(19) United States
(12) Patent Application Publication
(10) Pub. No.: US 2023/0419122 A1
(43) Pub. Date: Dec. 28, 2023

(54) Adaptive Learning Rates for Training Adversarial Models with Improved Computational Efficiency

(71) Applicant: Google LLC, Mountain View, CA (US)

(72) Inventors: Hussein Hazimeh, New York, NY (US); Natalia Borisovna Ponomareva, Hoboken, NJ (US)

(21) Appl. No.: 18/341,397

(22) Filed: Jun. 26, 2023

Related U.S. Application Data
(60) Provisional application No. 63/355,363, filed on Jun. 24, 2022.

(51) Int. Cl. G06N 3/094

(52) U.S. Cl. CPC G06N 3/094

(57) ABSTRACT

Provided are systems and methods that use a novel learning rate scheduling technique to dynamically adapt the learning rate of an adversarial model to maintain an appropriate balance between adversarial components of the model. The scheduling technique is driven by the fact that, in some settings, the loss of an ideal adversarial network can be analytically determined a priori. A scheduler component can thus operate to keep the loss of the optimized network close to that of an ideal adversarial net.

### RELATED APPLICATIONS

This application claims priority to and the benefit of U.S. Provisional Patent Application No. 63/355,363, filed Jun. 24, 2022. U.S. Provisional Patent Application No. 63/355,363 is hereby incorporated by reference in its entirety.

### FIELD

The present disclosure relates generally to machine learning. More particularly, the present disclosure relates to systems and methods that use adaptive learning rates to train adversarial models with improved computational efficiency.

### BACKGROUND

Adversarial networks have proven successful in generative modeling, transfer learning (e.g., domain adaptation, generalization, etc.), fairness, privacy, and other domains. Generative Adversarial Nets (GANs) are a foundational example of this class of models (See Goodfellow et al., 2014). Given a finite sample from a target distribution, a GAN aims to generate more samples from that distribution. This is achieved by training two competing networks. A generator G transforms noise samples into the sample space of the target distribution, and a discriminator D attempts to distinguish between the real and generated samples. To generate realistic samples, G is trained to fool D, while D is trained to avoid being fooled by G. Adversarial nets used in domains other than generative modeling follow the same principle of training two competing networks.

Training an adversarial network typically requires solving a nonconvex, non-concave min-max optimization problem, which is notoriously challenging. In practice, first-order methods are commonly used as a heuristic for this problem. One popular choice is Stochastic Gradient Descent Ascent (SGDA), which is an extension of SGD that takes gradient descent and ascent steps over the min and max problems, respectively. SGDA and its adaptive variants (e.g., based on Adam) are the de facto standard for optimizing adversarial nets. These methods typically require choosing two base learning rates; one for each competing network.

However, adversarial nets are very sensitive to the learning rates, and careful choices are needed to maintain a balance between the competing networks. In practice, the same learning rate is often used for both networks, even though decoupled rates can lead to improvements. The base learning rates typically used in the literature are constant or can be decayed during training. In either case, these rates do not depend on knowledge about the best possible state of the network.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for training adversarial models with improved computational efficiency. The method includes obtaining, by a computing system comprising one or more computing devices, one or more training samples. The method includes processing, by the computing system, the one or more training samples with an adversarial machine learning model to generate one or more outputs, wherein the adversarial machine learning model comprises at least a first model component and a second model component that are adversarial to each other. The method includes evaluating, by the computing system, a loss function based at least in part on the one or more outputs to determine a current loss value associated with the adversarial machine learning model. The method includes determining, by the computing system, a distance between the current loss value associated with the adversarial machine learning model and an ideal loss value for the adversarial machine learning model. The method includes determining, by the computing system, an adaptive learning rate value for at least one of the first model component and the second model component based at least in part on the distance between the current loss value associated with the adversarial machine learning model and the ideal loss value for the adversarial machine learning model. The method includes updating, by the computing system, the at least one of the first model component and the second model component according to the adaptive learning rate value.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example system for training an adversarial model according to example embodiments of the present disclosure.

FIG. 1B depicts a block diagram of an example system for training a generative adversarial neural network according to example embodiments of the present disclosure.

FIG. 1C depicts a block diagram of an example system for training a domain adversarial neural network according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that use a novel learning rate scheduling technique to dynamically adapt the learning rate of an adversarial model to maintain an appropriate balance between adversarial components of the model. The scheduling technique is driven by the fact that, in some settings, the loss of an ideal adversarial network can be analytically determined a priori. A scheduler component can thus operate to keep the loss of the optimized network close to that of an ideal adversarial net.

As described in U.S. Provisional Patent Application No. 63/355,363, large-scale experiments were run to study the effectiveness of the scheduler on two popular applications: GANs for image generation and domain adversarial network networks (DANNs) for domain adaptation. The experiments indicate that adversarial nets trained with the scheduler are less likely to diverge and require significantly less tuning, thereby enabling more efficient model training and conserving computational resources. For example, on CelebA, a GAN with the scheduler requires only one-tenth of the tuning budget needed without a scheduler. Moreover, the scheduler leads to statistically significant improvements, reaching up to 27% in the Frechet Inception Distance for image generation and 3% in test accuracy for domain adaptation. Thus, in addition to improving the computational efficiency with which the model can be trained, the proposed techniques also improve the performance of the model and computer itself.

More particularly, the present disclosure demonstrates that it is beneficial to dynamically choose the learning rate of some or all of the model components based on the current state of the adversarial net. For example, training can be significantly enhanced (e.g., sped up). Specifically, example systems can include a learning rate scheduler that dynamically changes (e.g., scales) the learning rate of existing optimizers (e.g., Adam), based on the current loss of the network and knowledge about the ideal state of the network. In some example implementations, the scheduler is driven by the following key observation: in many popular formulations, the loss of an ideal adversarial network is able to be analytically determined a priori. For example, an ideal GAN is one in which the distributions of the real and generated samples match. Therefore, an optimality gap can be defined. Specifically, the optimality gap can refer to the distance (e.g., absolute difference, L2 distance, etc.) between the losses of the current and ideal adversarial nets.

Thus, one insight underlying the proposed approach is that adversarial nets trained to achieve smaller optimality gaps tend to perform better. U.S. Provisional Patent Application No. 63/355,363 presents empirical evidence that verifies this insight on different loss functions and datasets. Motivated by this insight, example systems can include a scheduler that keeps track of the optimality gap. At each optimization step, the scheduler can decide whether to increase or decrease the base learning rate of some or all of the adversarial components (e.g., the discriminator in a GAN), in order to keep the optimality gap relatively small. The base learning rate of the competing network (e.g., the generator in a GAN) can optionally be kept constant, since controlling the loss of one of the adversaries (e.g., by scaling its base learning rate) effectively modifies that of the adversary. For example, if the game is zero-sum, an increase in the loss of the discriminator will lead to a decrease in the loss of the competing network with an equal magnitude (and vice versa). While the description above makes reference to adapting the learning rate of a discriminator in a GAN while leaving the learning rate of the generator fixed, the opposite arrangement can be performed as well—that is, adapting the learning rate of a generator in a GAN while leaving the learning rate of the discriminator fixed.

Example experimental data contained in U.S. Provisional Patent Application No. 63/355,363 demonstrates the effectiveness of the scheduler empirically in two popular use cases: GANs for image generation and Domain Adversarial Neural Nets (DANN) (See Ganin et al., 2016) for domain adaptation. In both cases, it is observed that use of the proposed scheduler significantly reduces the need for tuning (e.g., of up to 10× in many cases) and can lead to significant improvements in the main performance metrics (image quality or accuracy) on standard benchmarks: CelebA (Liu et al., 2015), CIFAR-10 (Krizhevsky et al., 2009), MNIST (LeCun & Cortes, 2010), Fashion NIST (Xiao et al., 2017), and MNIST-M (Ganin & Lempitsky, 2015).

Thus, the present disclosure proposes a novel scheduler that adapts the base learning rate of component(s) of an adversarial model to keep the optimality gap relatively small and maintain a balance with the competing network. By adapting the learning rate in this fashion, the adversarial model can generate higher quality samples or otherwise demonstrate superior performance. The proposed scheduler can be used with any of the popular optimizers and is simple to implement. Experiments were performed on two popular adversarial nets: GANs and DANN. For GANs, large-scale tuning studies were conducted on four benchmark datasets and demonstrate that the scheduler improves image quality by up to 27% (measured by Frechet Inception Distance) and requires significantly less tuning. The experiments on domain adaptation (DANN) also indicate that the scheduler leads to statistically significant improvements in the accuracy on the target domain (up to 3%), while requiring less tuning.

Thus, the present disclosure provides a number of technical effects and benefits. As one example technical effect and benefit, the proposed adaptive learning rate scheduling technique can enable training adversarial models with improved computational efficiency. For example, adversarial models can be tunedfaster (i.e., using fewer tuning iterations and/or fewer tuning hyperparameters). Tuning models faster can enable a reduction in the number of computer resources consumed, such as reduced processor usage, reduced memory usage, reduced network bandwidth consumption, etc.

As another example technical effect and benefit, the proposed adaptive learning rate scheduling technique can enable improved model outputs. For example, the quality of the outputs (e.g., the outputs of a generator or feature extractor) can be improved. For example, a GAN can generate outputs that better match a real distribution. This can represent or lead to improved performance of the model or an implementing computer system on a number of different tasks. Thus, the proposed adaptive learning rate scheduling technique improves the performance of a computer itself.

With reference now to the Figures, example embodiments of the present disclosure will be discussed in further detail.

### Example Adversarial Nets and their Ideal Loss

Example Generative Adversarial Nets (GANs)

This section first introduces some notation. Let [symbol] ᵣ, be the real distribution and [symbol] ₙ, be some noise distribution. The generator G is a function that maps samples from [symbol] ₙ to the sample space of [symbol] ᵣ (e.g., space of images). We define [symbol] _{g} as the distribution of \tilde{x}: =G(z) where z˜ [symbol] ₙ, i.e., [symbol] _{g}, is distribution of generated samples. The discriminator D is a function that maps samples from G to a real value.

Standard GAN and its Ideal Loss: The standard GAN introduced by [Goodfellow et al., 2014] can be written as:

$${min}_{G} {max}_{D} {𝔼}_{x \sim {ℙ}_{r}} log D ( x ) + {𝔼}_{\tilde{x} \sim {ℙ}_{g}} log ( 1 - D ( \tilde{x} ) ) ,$$

where D in this case outputs a probability. In practice, we have a finite sample from [symbol] ᵣ so it is replaced by the corresponding empirical distribution. Moreover, the expectation over [symbol] _{g} is estimated by sampling from the noise distribution.

It can be said that a GAN is ideal if the generated and real samples follow the same distribution, i.e. [symbol] _{g}= [symbol] ᵣ. When the standard GAN is ideal, the objective function becomes:

$${max}_{D} {𝔼}_{x \sim {ℙ}_{r}} [ log D ( x ) + log ( 1 - D ( x ) ) ] .$$

The solution to the problem above is given by D(x)=0.5 for all x in the support of [symbol] ᵣ. Thus, the optimal objective is −log(4). Example implementations of the present disclosure focus on the loss, i.e., the negative of the utility discussed above. The optimal loss of D in an ideal GAN will be denoted by V*, so in this case V*=log(4). This quantity allows for computing the optimality gap, which is essential for the operation of the scheduler.

Popular GAN variations considered in this work are as follows. Both the discriminator and generator losses are minimized. The value V* denotes the loss of the discriminator in an ideal GAN.

| | Discriminator | Generator | Ideal |
|---|---|---|---|
| | Loss | Loss | Discriminator |
| GAN | (Minimized) | (Minimized) | Loss V* |
| Standard | − [symbol] [log(D(x))] − | [symbol] [log(1 − | log(4) |
| | [symbol] [log(1 − D(\tilde{x}))] | D(\tilde{x}))] | |
| NSGAN | − [symbol] [log(D(x))] − | − [symbol] | log(4) |
| | [symbol] [log(1 − D(\tilde{x}))] | [log(D(\tilde{x}))] | |
| WGAN | − [symbol] [D(x)] + | − [symbol] [D(\tilde{x})] | 0 |
| | [symbol] [D(\tilde{x})] | | |
| LSGAN | [symbol] [(D(x) − 1)²] + | [symbol] [(D(\tilde{x} − | 0.5 |
| | [symbol] [D(\tilde{x})²] | 1))²] | |

Popular GAN Variants: While the standard GAN is conceptually appealing, the gradients of the generator may vanish early on during training. To mitigate this issue, [Goodfellow et al., 2014] proposed the non-saturating GAN (NSGAN), which uses the same objective for D, but replaces the objective of G with another that (directly) maximizes the probability of the generated samples being real. Similar to the standard GAN, the optimal discriminator loss of an ideal NSGAN is V*=log(4).

Many follow-up works have proposed alternative loss functions and divergence measures in attempt to improve the quality of the generated samples, e.g., see [Arjovsky et al., 2017, Mao et al., 2017, Nowozin et al., 2016, Li et al., 2017] and [Wang et al., 2021] for a survey. The table above presents the objective functions of two popular GAN formulations: Wasserstein GAN (WGAN) and least-squares GAN (LSGAN) [Arjovsky et al., 2017, Mao et al., 2017]. WGAN uses a similar formulation to the standard GAN but drops the log, and D outputs a logit (not a probability). [Arjovsky et al., 2017] shows that under an optimal k-Lipschitz discriminator, WGAN minimizes the Wasserstein distance between the real and generated distributions. LSGAN uses squared-error loss as an alternative to cross-entropy, and [Mao et al., 2017] motivate this by noting that squared-error loss typically leads to sharper gradients.

Similar to an ideal standard GAN, the optimal discriminator losses of ideal WGAN and LSGAN are known constants-see the last column of the table above (these constants are derived by plugging [symbol] _{g}= [symbol] ᵣ in the discriminator loss).

Correlation Between the Optimality Gap and Sample Quality

For all the GAN formulations in the table above, it is known in theory that if the model capacity is sufficiently high, solving the optimization problem to global optimality leads to an ideal GAN [Goodfellow et al., 2014, Arjovsky et al., 2017, Mao et al., 2017]. However, in practice, the capacity of the GAN is limited and optimization is done using first-order methods, which are generally not guaranteed to obtain optimal solutions. Thus, obtaining an ideal GAN in practice is generally infeasible. However, it is possible to train GANs that are “close enough” to an ideal GAN in terms of the loss. Specifically, given a GAN whose discriminator loss is \hat{V}, the optimality gap can be defined as |\hat{V}−V*|.

The present disclosure therefore recognizes that GANs that achieve smaller optimality gaps tend to generate better samples. This statement applies to GANs that are trained with reasonable hyperparameters and initialization. It is possible to obtain GANs whose optimality gap is 0 or close to 0 without training, e.g., initializing a GAN with all-zero weights will lead to a 0 gap in standard GAN.

Domain Adversarial Neural Nets (DANN)

DANN is another important example of adversarial nets used in domain adaptation [Ganin et al., 2016]. Given labelled data from a source domain and unlabelled data from a related, target domain, the goal is to train a model that generalizes well on the target. The main principle behind DANN is that for good generalization, the feature representations should be domain-independent [Ben-David et al., 2010]. DANN consists oƒ: (i) a feature extractor F that receives features (from either the source or target data) and generates representations, (ii) a label predictor Y that classifies the source data based on the representations from the feature extractor, (iii) a discriminator D—a probabilistic classifier—that takes the feature representations from the extractor and attempts to predict whether the sample came from the source or target domain. Let [symbol] ₛ and [symbol] ₜ be the input distributions of the source and target domains, respectively. At the population level, DANN solves:

$${min}_{F , Y} {max}_{D} {ℒ}_{y} ( F , Y ) - {λℒ}_{d} ( F , D ) ,$$

where [symbol] _{y}(F, Y) is the risk of the label predictor, λ is a non-negative hyperparameter, and [symbol] _{d}(F, D) is the discriminator risk defined by:

− [symbol] log[D(F(x))]− [symbol] log[1−D(F(\tilde{x}))].

It can be said that DANN is ideal if the distribution of F(x), x˜ [symbol] ₛ is the same as that of F(\tilde{x}), \tilde{x}˜ [symbol] ₜ. By the same reasoning used for standard GAN, the optimal discriminator in this ideal case outputs 0.5, and thus [symbol] _{d}(F, D)=log(4). However, generally, A controls the extent to which the two distributions discussed above are matched, and thus the optimal [symbol] _{d}(F, D) generally depends on λ. Very small values of λ may lead to a discriminator that distinguishes well between the two domains. On the other hand, by increasing λ, we can get arbitrarily close the ideal case (where the discriminator outputs 0.5). In theory, for effective domain transfer, λ needs to be chosen large enough so that discriminator is well fooled [Ben-David et al., 2010], so for such λ's we expect the optimal [symbol] _{d}(F, D) to be roughly close to log(4). Finally, similar to GANs, note that the ideal case is typically infeasible to achieve in practice (due to several factors, including using first-order methods and limited capacity); but controlling the optimality gap can be useful

### Example Gap-Aware Learning Rate Scheduling

This section describes an example learning rate scheduler that attempts to keep the gap relatively small throughout training. Besides the hypothesized improvement in sample quality, keeping the optimality gap small throughout training can mitigate potential drifts in the loss (e.g., the discriminator loss dropping towards zero), which may lead to more stable training. Next, we describe the optimization setup and then introduce the scheduling algorithm.

Optimization Setup: some example implementations assume that the optimization problem of the adversarial net is cast as a minimization over both the loss of the adversary D (e.g., the discriminator in a GAN) and the loss of the competing network G (e.g., the generator in a GAN). Some example implementations focus on the popular strategy of optimizing the two competing networks simultaneously using (minibatch) SGD. The notation α_{d} is used to refer to the learning rate of D. The learning rate scheduler will modify ad throughout training whereas the learning rate of G remains fixed. Note that the scheduler can be applied to adaptive optimizers (e.g., Adam or RMSProp) as well—in such cases, ad will refer to the base learning rate. Denote by V_{d} the current loss of D (a scalar representing the average of the loss over the whole training data). The scheduler takes V_{d} and D's ideal loss V*as inputs and outputs a scalar, which is used as a multiplier to adjust α_{d}.

Effect of D's learning rate on the optimality gap: Recall that in an example setup D and G are simultaneously optimized. During each optimizer update, D aims to decrease V_{d} while G typically aims to increase V_{d}. The optimizer update may increase or decrease V_{d}, depending on how large D's learning rate is w.r.t. that of G. If D's learning rate is sufficiently larger, we expect V_{d} to decrease after the update, and otherwise, we expect V_{d} to increase. This insight is the basis of how the scheduler controls the optimality gap.

The section will now further describe the scheduling mechanism, where two cases are differentiated: (i) V_{d}≥V* and (ii) V_{d}<V*.

Scheduling when V_{d}≥V*. First, this section gives an abstract definition of the scheduler and then defines the scheduling function formally. In this case, the current loss of D is larger than V*, so to reduce the gap, we need to decrease V_{d}. As discussed earlier, this effect can be achieved by increasing D's learning rate sufficiently. Therefore, when V_{d}≥V*, the scheduler can increase the learning rate, and the increase can be proportional to the gap (V_{d}−V*), so that the scheduler focuses more on larger deviations from optimality.

There are a couple of important constraints that can be taken into account when increasing the learning rate. First, the increase can be bounded because too large of a learning rate will lead to convergence issues. Second, the rate of increase can be controlled to ensure the chosen rate works in practice (e.g., too fast of a rate can lead to sharp changes in the loss and cause instabilities). One example function that satisfies the desired constraints is described below.

A scheduling function can be expressed as ƒ: [symbol] →R, which takes x: =(V_{d}−V*) as an input and returns a multiplier for the learning rate. That is, the new learning rate of the discriminator (after scheduling) can be α_{d}×ƒ(x). To satisfy the example constraints discussed above (boundedness and rate control), two user-specified parameters can optionally be used: ƒₘₐₓ ∈ [1, ∞) and xₘₐₓ ∈ [symbol] _{>0}. The function ƒ interpolates between the points (0,1) and (xₘₐₓ, ƒₘₐₓ) and caps at ƒₘₐₓ, i.e., ƒ(x)=ƒₘₐₓ for x≥xₘₐₓ. Here xₘₐₓ is viewed as a parameter that controls the rate of the increase—a larger xₘₐₓ leads to a slower rate, and thus the scheduler becomes less stringent. There are different possibilities for interpolation. Example approaches include linear and exponential interpolation. Thus, some example implementations use exponential interpolation and define ƒ as:

$$f ( x ) = min \{ {[ {f}_{max} ]}^{\frac{x}{{x}_{max}}} , {f}_{max} \} . \qquad ( 1 )$$

Note that since ƒₘₐₓ≥1, we always have ƒ(x)≥1 for x≥0, so the learning rate will increase after scheduling. Moreover, the learning rate is not modified when the gap is zero since ƒ(0)=1.

Scheduling when V_{d} V*. In this case, reducing the gap requires increasing V_{d}. This can be achieved by decreasing the learning rate of D. Similar to the previous case, the scheduler can effect a decrease proportional to (V*−V_{d}) (a non-negative quantity). More formally, some example implementations define a scheduling function h: [symbol] → [symbol] , which takes x: =(V*−V_{d}) as an input and returns a multiplier for the learning rate, i.e., the new learning rate is α_{d}×h(x). Similar to the previous case, two user-specified parameters can be used hₘᵢₙ ∈ (0,1] (the minimum value h can take) and xₘᵢₙ ∈ R_{>0} to control the decay rate. Some example implementations define h as an interpolation between (0,1) and (xₘᵢₙ, hₘᵢₙ), which is clipped from below at hₘᵢₙ. Some example implementations use exponential decay interpolation, leading to:

$$h ( x ) = max \{ {[ {h}_{min} ]}^{\frac{x}{{x}_{min}}} , {h}_{min} \} . \qquad ( 2 )$$

Since hₘᵢₙ ∈ [0,1], we always have h(x)≤1 for x≥0, implying that the learning rate will decrease after scheduling. One example scheduling mechanism is described in Algorithm 1.

Algorithm 1: Gap-Aware Scheduling Algorithm

Inputs: Current loss V_{d} and ideal loss V*.

Parameters: xₘᵢₙ, xₘₐₓ, hₘᵢₙ ∈ (0,1], ƒₘₐₓ ∈ [1, ∞).

If V_{d}≥V*, increase D's learning rate by multiplying it with ƒ(V_{d}−V*) —see (1).

If V_{d}<V*, decrease D's learning rate by multiplying it with h(V*−V_{d}) —see (2).

Batch-level Scheduling. Some example implementations apply Algorithm 1 at the batch level, i.e., the learning rate is modified at each minibatch update. The motivation behind batch-level scheduling is to keep the loss in check after each update. One popular alternative is to schedule at the epoch level. However, if the epoch involves many batches, the loss may drift drastically throughout one or few epochs (an observation that is common in practice). Scheduling at the batch level can mitigate such drifts early on.

Estimating the Current Discriminator Loss. The scheduling algorithm requires access to the discriminator's loss V_{d} at every minibatch update. The loss can be evaluated over all training examples, however, this is typically inefficient. Some example implementations resort to an exponential moving average to estimate V_{d}. Specifically, let V_{d} be the current estimate of V_{d} and denote by V_{batch} the loss of the current batch (which is available from the forward pass). The moving average update is: \hat{V}_{d}←α\hat{V}_{d}+(1−α)V_{batch}, where α ∈ [0,1) is a user-specified parameter that controls the decay rate. Some example implementations fix α=0.95 (no tuning was performed) and initialize with V*. Note that if the training loss is evaluated periodically over the whole dataset (e.g., every number of epochs), the moving average can be reinitialized with this value.

Example Diagrams:

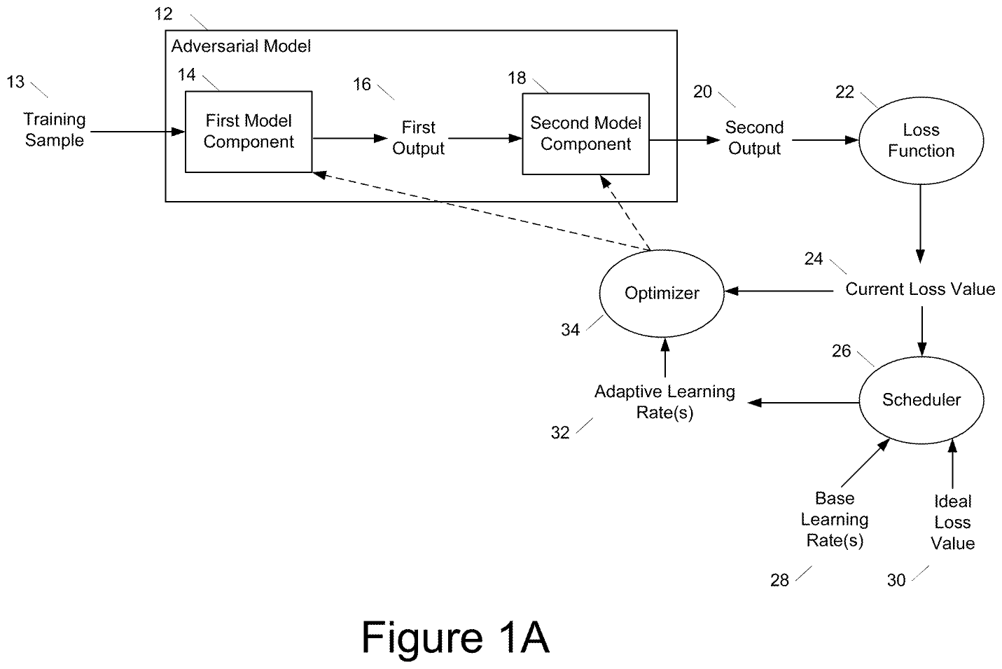

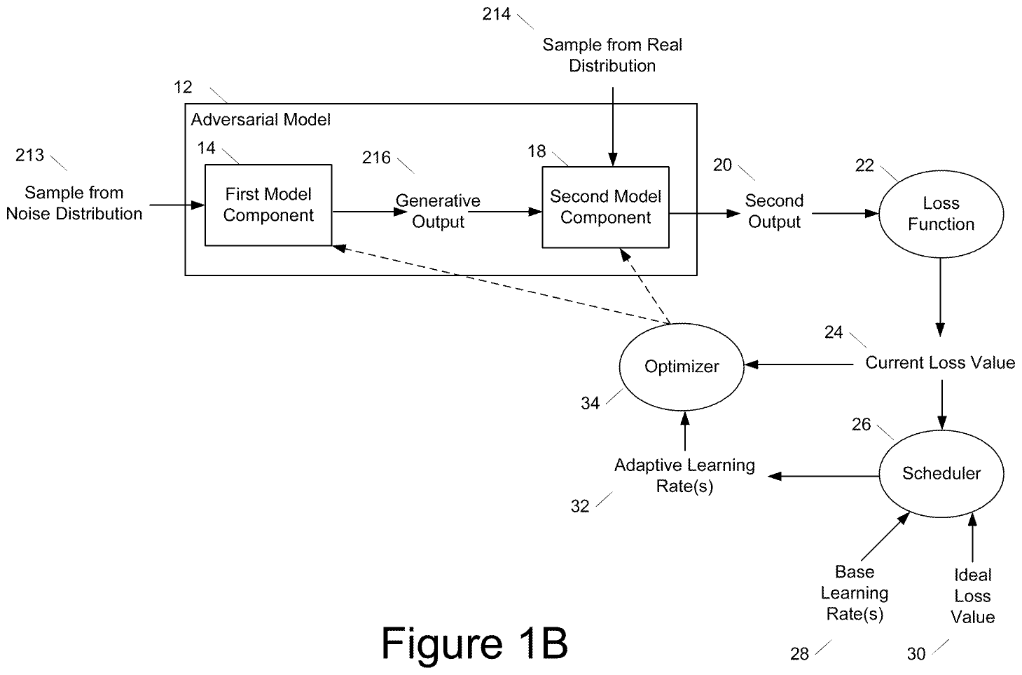

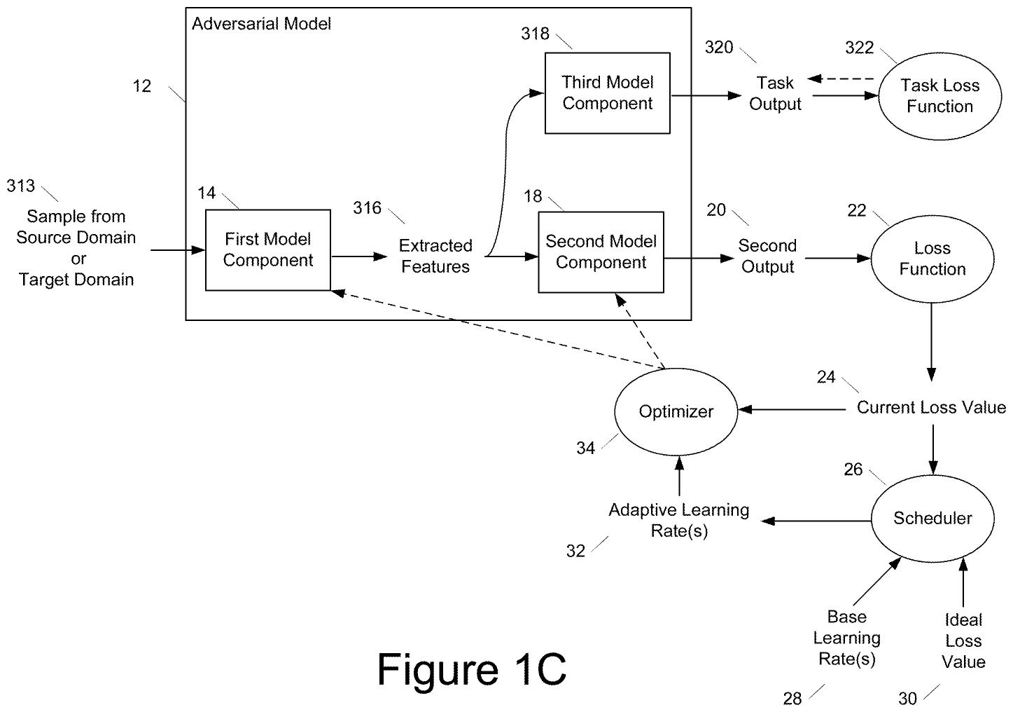

FIG. 1A depicts a block diagram of an example technique for training an example adversarial model 12 according to example embodiments of the present disclosure. The adversarial model 12 can include at least a first model component 14 and a second model component 16 that are adversarial to each other. In some implementations, the first model component 14 can be configured to generate a first output 16 and the second model component can be a discriminator model configured to generate a second output 20, where the second output 20 is or includes a probability that the first output 16 belongs to a first distribution (e.g., is included in the first distribution or is derived from data included in the first distribution).

Referring now to the training process illustrated in FIG. 1A, the process can include obtaining one or more training samples 13. Although one training sample is shown, the process can be performed on a batch of training samples in parallel.

The adversarial model 12 can process the training sample 13 to generate one or more outputs (e.g., output 16 and output 20, potentially among others). A loss function 22 can be evaluated based at least in part on the one or more outputs to determine a current loss value 24 associated with the adversarial machine learning model 12. For example, as illustrated in FIG. 1A, the loss function can explicitly evaluate the second output 20. However, other loss functions can evaluate other outputs of the model 12. The current loss value 24 for the model 12 can be the loss over the training sample 13, the loss over a batch of training samples 13, or a moving average of a loss over a number of training samples or batch(es) of training samples.

The current loss value 24 can be provided to a scheduler 26. The scheduler 26 can determine a distance between the current loss value 24 associated with the adversarial machine learning model 12 and an ideal loss value 30 for the adversarial machine learning model 12. The scheduler 26 can determine an adaptive learning rate value 32 for at least one of the first model component 14 and the second model component 18 based at least in part on the distance between the current loss value 24 associated with the adversarial machine learning model 12 and the ideal loss value 30 for the adversarial machine learning model 12. An optimizer 34 can update the at least one of the first model component 14 and the second model component 18 according to the adaptive learning rate value 32 (e.g., via backpropagation of the current loss value 24 with step size equal to the adaptive learning rate value 32).

In some implementations, the loss function 22 can be a minimax function. In some of such implementations, the first model component 14 may seek to minimize the minimax function while the second model component 18 seeks to maximize the minimax function. In some of such implementations, the ideal loss value 30 can correspond to a minimum value of the minimax function.

In some implementations, the ideal loss value 30 can correspond to the loss for the adversarial model 12 when the first output 16 of first model component 14 is indistinguishable, by the second model component 18, from a target distribution (e.g., a real distribution or a target distribution relative to a source distribution). In some implementations, the ideal loss value 30 can occur when the probability output by the discriminator model (e.g., as the second output 20) is equal to one half.

In some implementations, the adaptive learning rate 32 may be determined and/or applied only to the second model component 18. In some of such implementations, the first model component 14 can be updated using a fixed learning rate value.

In other implementations, the adaptive learning rate 32 may be determined and/or applied only to the first model component 14. In some of such implementations, the second model component 18 can be updated using a fixed learning rate value.

In other implementations, the adaptive learning rate 32 may be determined and/or applied to both the first model component 14 and the second model component 18.

In some implementations, the scheduler 26 can determine a learning rate scaling value based at least in part on the distance between the current loss value 24 and the ideal loss value 30. The scheduler 26 can scale a base learning rate value 28 by the learning rate scaling value to obtain the adaptive learning rate value 32.

In some implementations, when the current loss value 24 is greater than the ideal loss value 30, the learning rate scaling value is greater than or equal to one; while when the current loss value 24 is less than the ideal loss value 30, the learning rate scaling value is greater than zero and less than or equal to one.

In some implementations, when the current loss value 24 is greater than the ideal loss value 30, the scheduler 36 can evaluate a first scheduling function with an argument of the distance between the current loss value associated with the adversarial machine learning model and the ideal loss value for the adversarial machine learning model. Conversely, when the current loss value 24 is less than the ideal loss value 30, the scheduler 36 can evaluate a second scheduling function with an argument of the distance between the current loss value associated with the adversarial machine learning model and the ideal loss value for the adversarial machine learning model. In some implementations, the first scheduling function can perform linear or exponential interpolation between one and a maximum value while the second scheduling function can perform linear or exponential interpolation between a minimum value and one.

As one example, the adversarial model 12 can be a generative adversarial network (GAN). Application of the proposed framework to an example GAN is shown in FIG. 1B. In some example GANs, the first model component 14 can be a generator network and the second model component 18 can be a discriminator network. The generator network can generate a generative output 216 from a sample from a noise distribution 213. For example, the output can be a synthetic image, generated text, generated sensor data, and/or any other modality of generative data. The discriminator network can receive an input (e.g., the first output 16 from the first model component 14 or a sample from a real distribution 214) and can provide the second output 20. The second output 20 can include or indicate a probability that the input to the discriminator is from the real distribution (or, conversely, a probability that the input to the discriminator is not from the real distribution; e.g., belongs to a noise distribution). The loss function 22 can evaluate whether the discriminator network has correctly discriminated between a generative output 216 and a sample from the noise distribution 214. The loss function 22 can penalize the discriminator for providing an incorrect output and reward the discriminator for providing a correct output. Conversely, the loss function 22 can reward the generator if the discriminator provides an incorrect output while penalizing the generator if the discriminator provides a correct output.

As another example, the adversarial model 12 can be a domain adversarial neural network (DANN). Application of the proposed framework to an example DANN is shown in FIG. 1C. In some example DANNs, the first model component 14 can be a feature extraction network configured to generate extracted features 316 from an input 313. The input 313 can be a sample from either a source domain or a target domain. The second model component can be a discriminator network configured to receive the extracted features 316 and generate the second output 20, where the second output 20 indicates a probability that the features were extracted from a sample from the source domain or from the target domain. The loss function 22 can penalize the discriminator for providing an incorrect output and reward the discriminator for providing a correct output. Conversely, the loss function 22 can reward the feature extraction network if the discriminator provides an incorrect output while penalizing the feature extraction network if the discriminator provides a correct output. The DANN can also include a third model component 318. The third model component 318 can generate a task output 320 based on the extracted features 316. For example the task output 320 can be a classification output, a detection output, a recognition output, etc. A task loss function 322 can evaluate the task output 320 (e.g., against a ground truth label). The task loss function 322 can be backpropagated to the third model component 318 and optionally the first model component 14 as well.

### Example Devices and Systems

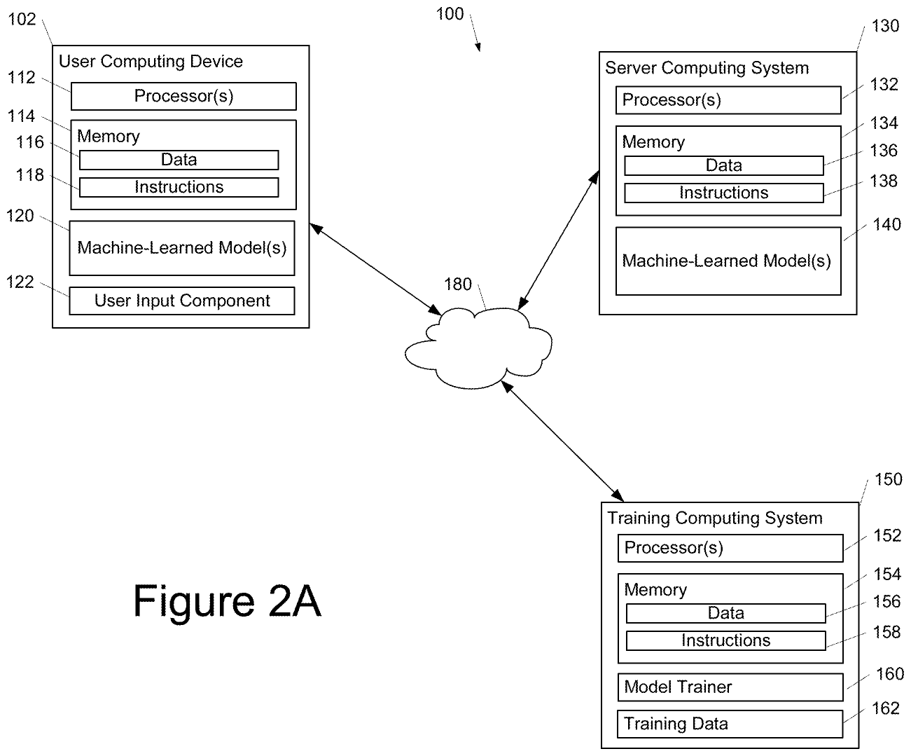

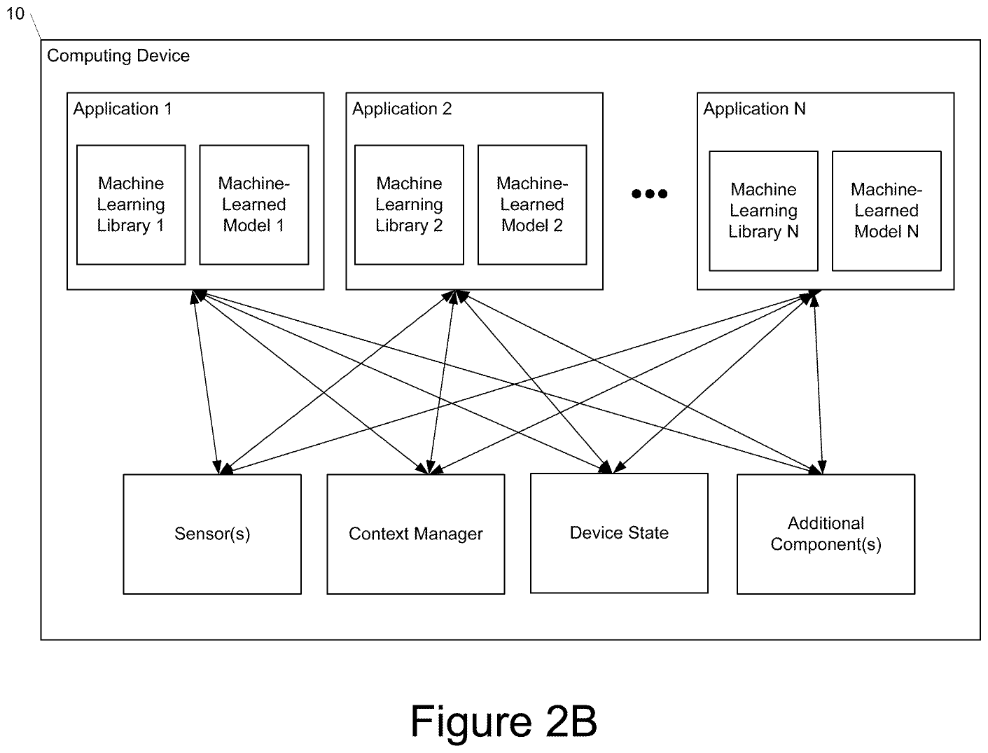

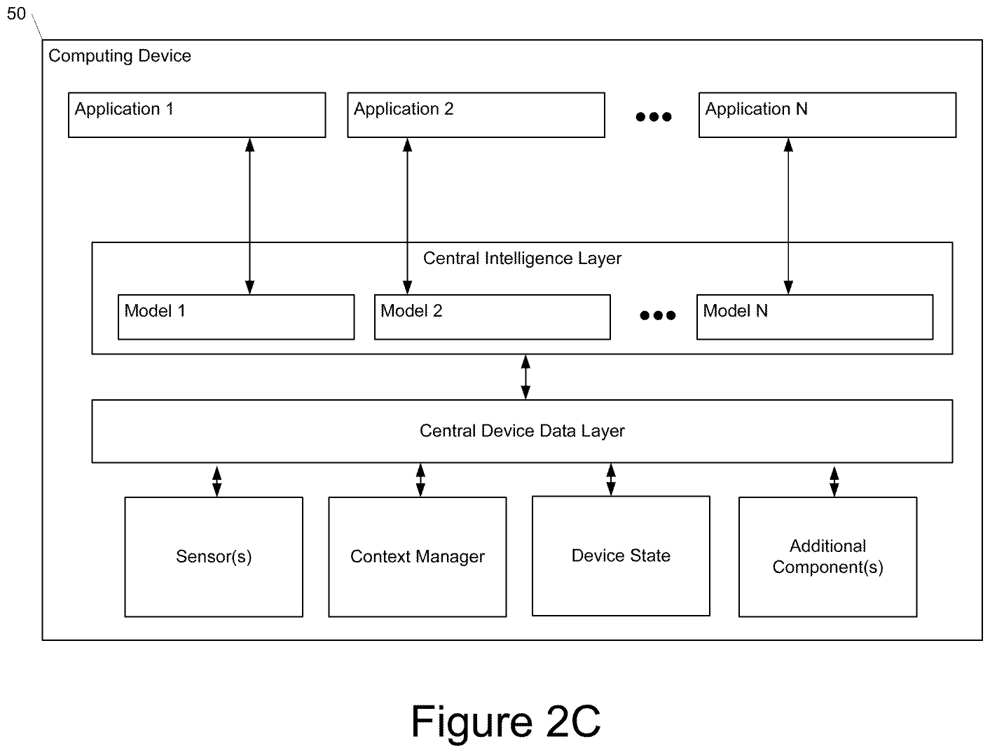

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine learning models 120. For example, the machine learning models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine learning models 120 are discussed with reference to FIG. 1A.

In some implementations, the one or more machine learning models 120 can be received from the server computing system 130 over network 180, stored in the user computing device memory 114, and then used or otherwise implemented by the one or more processors 112. In some implementations, the user computing device 102 can implement multiple parallel instances of a single machine learning model 120.

Additionally or alternatively, one or more machine learning models 140 can be included in or otherwise stored and implemented by the server computing system 130 that communicates with the user computing device 102 according to a client-server relationship. For example, the machine learning models 140 can be implemented by the server computing system 140 as a portion of a web service (e.g., a generative service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine learning models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIG. 1A.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. The model trainer 160 can implement or perform the operations described for the scheduler and/or optimizer as illustrated in and discussed with reference to FIG. 1A.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine learning models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for training adversarial models with improved computational efficiency, the method comprising:
obtaining, by a computing system comprising one or more computing devices, one or more training samples;
processing, by the computing system, the one or more training samples with an adversarial machine learning model to generate one or more outputs, wherein the adversarial machine learning model comprises at least a first model component and a second model component that are adversarial to each other;
evaluating, by the computing system, a loss function based at least in part on the one or more outputs to determine a current loss value associated with the adversarial machine learning model;
determining, by the computing system, a distance between the current loss value associated with the adversarial machine learning model and an ideal loss value for the adversarial machine learning model;
determining, by the computing system, an adaptive learning rate value for at least one of the first model component and the second model component based at least in part on the distance between the current loss value associated with the adversarial machine learning model and the ideal loss value for the adversarial machine learning model; and
updating, by the computing system, the at least one of the first model component and the second model component according to the adaptive learning rate value.

2. The computer-implemented method of claim 1, wherein:
the loss function comprises a minimax function;
the first model component seeks to minimize the minimax function;
the second model component seeks to maximize the minimax function; and
the ideal loss value comprises a minimum value of the minimax function.

3. The computer-implemented method of claim 1, wherein:
the first model component is configured to generate a first output;
the second model component comprises a discriminator model configured to generate a second output comprising a probability that the first output belongs to a first distribution; and
the ideal loss value occurs when the probability output by the discriminator model is equal to one half.

4. The computer-implemented method of claim 3, wherein:
the adversarial machine learning model comprises a generative adversarial network;
the first model component comprises a generator network configured to generate the first output; and
the second model component comprises a discriminator network.

5. The computer-implemented method of claim 4, wherein the generator network is configured to generate a synthetic image.

6. The computer-implemented method of claim 3, wherein
the adversarial machine learning model comprises a domain adversarial neural network;
the first model component comprises a feature extraction network configured to generate the first output comprising extracted features;
the second model component comprises a discriminator network; and
the domain adversarial neural network comprises a third model component configured to generate a task output based on the extracted features.

7. The computer-implemented method of claim 1, wherein:
determining, by the computing system, the adaptive learning rate value for the at least one of the first model component and the second model component comprises determining, by the computing system, the adaptive learning rate value for the second model component; and
updating, by the computing system, the at least one of the first model component and the second model component according to the adaptive learning rate value comprises updating, by the computing system, the second model component according to the adaptive learning rate value.

8. The computer-implemented method of claim 7, further comprising:
updating, by the computing system, the first model component according to a fixed learning rate value.

9. The computer-implemented method of claim 1, wherein the first model comprises an image synthesis model.

10. The computer-implemented method of claim 1, wherein determining, by the computing system, the adaptive learning rate value for at least one of the first model component and the second model component based at least in part on the distance between the current loss value associated with the adversarial machine learning model and the ideal loss value for the adversarial machine learning model comprises:
determining, by the computing system, a learning rate scaling value for the at least one of the first model component and the second model component based at least in part on the distance between the current loss value associated with the adversarial machine learning model and the ideal loss value for the adversarial machine learning model; and
scaling, by the computing system, a base learning rate value by the learning rate scaling value to obtain the adaptive learning rate value.

11. The computer-implemented method of claim 10, wherein:
when the current loss value is greater than the ideal loss value, the learning rate scaling value is greater than or equal to one;
when the current loss value is less than the ideal loss value, the learning rate scaling value is greater than zero and less than or equal to one.

12. The computer-implemented method of claim 10, wherein determining, by the computing system, the learning rate scaling value comprises:
when the current loss value is greater than the ideal loss value, evaluating a first scheduling function with an argument of the distance between the current loss value associated with the adversarial machine learning model and the ideal loss value for the adversarial machine learning model; and
when the current loss value is less than the ideal loss value, evaluating a second scheduling function with an argument of the distance between the current loss value associated with the adversarial machine learning model and the ideal loss value for the adversarial machine learning model.

13. The computer-implemented method of claim 12, wherein:
the first scheduling function comprises linear or exponential interpolation between one and a maximum value; and
the second scheduling function comprises linear or exponential interpolation between a minimum value and one.

14. The computer-implemented method of claim 1, wherein the ideal loss value comprises the loss for the machine learning system when an output of first model component is indistinguishable, by the second model component, from a target distribution.

15. The computer-implemented method of claim 1, wherein the one or more training samples comprise a batch of a plurality of training samples.

16. The computer-implemented method of claim 1, wherein the current loss value comprises an exponential moving average of a model loss over a number of batches.

17. A computer system comprising:
one or more processors;
at least a first machine learning component,
wherein the first machine learning component was trained using the adaptive learning rate as described in any preceding claim, or
wherein the first machine learning component was jointly trained with a second machine learning component trained using the adaptive learning rate as described in any preceding claim; and
one or more non-transitory computer-readable media that store instructions that, when executed by the one or more processors, cause the computer system to run at least the first machine learning component.

18. The computer system of claim 17, wherein the first machine learning component was jointly trained with the second machine learning component using a loss function and the adaptive learning rate, wherein:
the loss function comprises a minimax function;
the first model component seeks to minimize the minimax function;
the second model component seeks to maximize the minimax function; and
the ideal loss value comprises a minimum value of the minimax function.

19. The computer system of claim 17, wherein:
the first model component is configured to generate a first output;
the second model component comprises a discriminator model configured to generate a second output comprising a probability that the first output belongs to a first distribution; and
the ideal loss value occurs when the probability output by the discriminator model is equal to one half.

20. The computer system of claim 17, wherein:
the adversarial machine learning model comprises a generative adversarial network;
the first model component comprises a generator network configured to generate the first output; and
the second model component comprises a discriminator network.
